(19) United States
(12) Patent Application Publication
(10) Pub. No.: US 2006/0137899 A1
(43) Pub. Date: Jun. 29, 2006

(54) Extruded elastic insulation for conductors of electric machines

(76) Inventors: Klaus Schafer, Nurnberg (DE); Gerhard Maul, Nurnberg (DE); Martin Kaufhold, Nurnberg (DE)

Correspondence Address: HENRY M FEIEREISEN, LLC, 350 FIFTH AVENUE, SUITE 4714, NEW YORK, NY, 10118, US

(21) Appl. No.: 10/540,200

(22) PCT Filed: Dec. 5, 2003
(86) PCT No.: PCT/DE03/04004

§ 371 Date: Jan. 30, 2006

(30) Foreign Application Priority Data
Dec. 20, 2002 (DE) 10260315.4

(51) Int. Cl. H01B 5/08

(52) U.S. Cl. 174/128.1

(57) ABSTRACT

The insulation of conductors comprised of litz wires of an electric machine should be improved for certain applications. To this end, the litz conductors of an electric machine are insulated by means of extrusion. A litz wire comprised of a multitude of filaments (1) is surrounded in a simple manner by an insulation (2) that completely insulates the litz wire from the surroundings. The spaces between the individual filaments (1) are preferably filled with a thermoconductive material also by means of extrusion.

The present invention relates to a stranded conductor for forming an electric conductor, in particular a subconductor, for a winding of an electric machine with an arrangement of several, mutually substantially parallel and/or twisted filaments, and an insulation which surrounds the arrangement of filaments on their exterior circumference. The present invention also is directed to a corresponding method for producing electrical conductors for electric machines.

In certain applications, windings for electric machines are implemented as pulled coils, which are preferably made of rectangular conductors. To date, solid conductors are typically used for the rectangular copper conductors. Alternatively, bare or insulated stranded wires made of copper or aluminum, which are rolled into rectangular profiles, can also be used.

Solid rectangular wires are typically insulated by varnishing, extrusion or covering with insulating tapes (foils, Mica, paper, glass or plastic fibers) or combinations thereof. Such insulation is also referred to as subconductor insulation or conductor insulation. In addition, a primary insulation is to be applied to electrically insulate the conductor from ground potential, i.e., from the stator or rotor armature. The primary insulation typically consists of insulating tapes applied in several layers (Mica tapes, broad web materials with a different backings). Windings operating at low nominal voltages can be insulated by a multi-layer slot coating made of, for example, aromatic polyamides, foils or Mica. The entire winding is impregnated with a suitable impregnating compound by an immersion or VPI method.

The subconductor insulation, i.e., the insulation between the conductors and between windings, and the primary insulation, i.e., the insulation to ground and between the strands in the slot and winding end region of the winding, of windings of electric machines operating at high voltages is in typically manufactured from fine Mica tapes with glass fiber and/or foil backings. A conducting outer corona shielding and optionally an end corona shielding are employed as an outer layer in the slot region for controlling the potential. A covered tape with a smooth surface, which is insensitive to contamination, is used in the winding head. The thickness of the primary insulation is adapted to the nominal voltage of the machine as well as to the operating and manufacturing requirements.

In embodiments of pulled coils operating at low voltages, the subconductor insulation consists, for example, of organic varnishes and, depending on the requirements, of an additional surrounding spin coating with foils or glass filaments. The primary insulation in the slot region is implemented, for example, with multi-layer surface-insulating materials made of aromatic polyamide paper and foils and/or Mica foils (Mica surface material). The insulation between phases is realized with air gaps in the winding head or with insulating materials in the slot region.

Insulating the various windings is very time-consuming and expensive.

It is therefore an object of the present invention to provide an insulation for windings of electric machines which can be easily manufactured.

The object is solved by the invention by a stranded conductor for forming an electric conductor, in particular a subconductor, for a winding of an electric machine with an arrangement of several mutually parallel and/or twisted filaments, and an insulation which surrounds the arrangement of filaments along its exterior circumference,

whereby the insulation is applied around the arrangement of the filaments by extrusion.

The invention also provides a method for producing electric conductors, in particular subconductors for a winding of an electric machine, by arranging several filaments in mutually substantially parallel and/or twisted relationship to form a stranded conductor, and by insulating the stranded conductor along its exterior circumference, whereby the insulation is applied by extrusion.

Advantageously, the extruded sheath increases the dimensional stability of the stranded conductor. In addition, extrusion can provide a very dense insulation for special winding applications, e.g., in wet environments or underwater.

Plastic insulations can be applied by extrusion to stranded conductors of arbitrary shape. This is advantageous, in particular, for subconductors with rectangular cross-section. In this way, the complex insulation process for the subconductors can be considerably simplified.

Moreover, an insulating layer applied by extrusion can readily provide an insulation with different wall thicknesses. In this way, for example, subconductors can be manufactured, wherein the insulation satisfies at least in certain sections of the circumference the requirements of a primary insulation. The manufacturing process for electric machines can be further simplified by combining the insulation of the subconductors and the primary insulation.

Extrusion is not only capable of applying a plastic insulation to the outer circumference of the stranded conductor, but can also fill the cavities inside the stranded conductor with an elastic, plastic material. Heat transfer between the individual conductors of the stranded conductor can be improved by using thermally conducting elastic extruded materials.

To affect the stability of the stranded conductor within certain limits, the insulating material applied by extrusion can be pressed at least partially into the cavities between the stranded wires. In this case, the filling material inside the stranded wire is the same as the material of the outer insulation.

Materials for increasing the thermal conductivity can also be added to the insulating material used for the outer insulation of the stranded wires. In this way, the generated heat can be better dissipated from the conductors, for example, to the armature or the surrounding air.

The present invention will now be described in more detail with reference to the appended drawings, which show in:

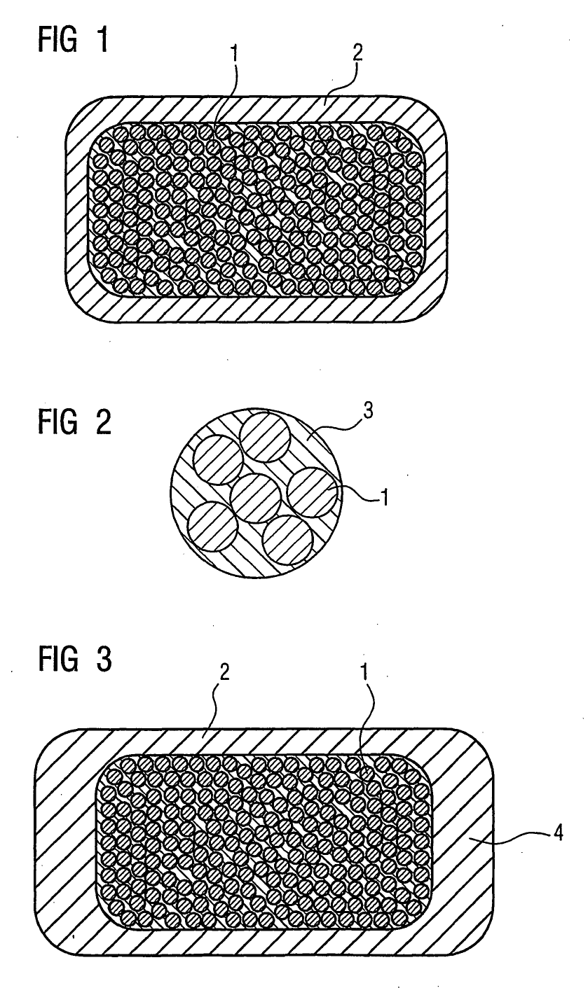

FIG. 1 a cross-section through an insulated subconductor according to the invention;

FIG. 2 an enlarged detail of the interior region of the subconductor of FIG. 1; and

FIG. 3 a cross-section through a subconductor according to another embodiment of the present invention.

The following exemplary embodiments represent preferred embodiments of the present invention.

FIG. 1 shows a cross-sectional view of a subconductor made of stranded wire. The conductor region consists of a plurality of filaments 1 and is rolled into a rectangular shape. The conductor region is surrounded by an extruded subconductor insulation 2.

The interstices between the individual conductors and filaments 1, respectively, of the stranded conductor are also filled with a plastic material by extrusion. FIG. 2 shows a detail of the conductor region of FIG. 1.

The subconductor insulation 2 disposed on the rectangular conductor made of flat stranded wire (pressed conductor) is preferably formed of a high-temperature thermoplastic material. Regarding the insulating materials and, in particular, the high-temperature thermoplastic material, explicit reference is made to the patent application Ser. No. 197 48 529 of the applicant. Potentially existing cavities between the stranded wires can be filled by a single-stage or multistage extrusion process (co-extrusion), which can stabilize and compress the conductor while the elasticity of the material helps retain a high flexibility. The surrounding subconductor insulation 2, on the other hand, is formed of a material which is similarly elastic, but harder.

The filling material 3 between the stranded wires of the rectangular conductor is also made of a thermally conducting material. This improves the unfavorable heat dissipation achieved with standard stranded conductors and increases the power density of the machine.

The filling material can also have a low electrical conductivity, which somewhat equilibrates the potential between the individual filaments 1 of the rectangular conductor. This can reduce the maximum field strength, in particular near the edges of the rectangular conductor. To provide an outer corona shield, the outer layer of the extruded subconductor insulation or primary insulation can also be made conducting by co-extrusion. The corona shield at the ends can be eliminated when employing the outer conducting layer applied by co-extrusion.

Another embodiment of the present invention is shown schematically in FIG. 3. The wall thickness of the insulation in the region of the narrow sides of the rectangular conductor is increased compared to the embodiment of FIG. 1. The wall thickness of the insulation 2 in the region of the longitudinal sides of the rectangular conductor, on the other hand, corresponds to the wall thickness of the insulation of the subconductors of the embodiment of FIG. 1. The enhanced insulation 4 satisfies the requirements of a primary insulation. It is then possible to produce both the subconductor insulation 2 and the primary insulation 4 in a single extrusion step. Several such rectangular subconductors can now be inserted, one upon the other, in the slot of a laminated armature of an electric machine. Only one an additional insulation needs to be provided on the bottom of the slots, because the longitudinal side of the lowest subconductor, which has only the subconductor insulation 2, rests on the slot bottom. With the integratable primary insulation 4, windings with a relatively low nominal voltage without a separate primary insulation can be produced by a simple process. In summary, the combination of a stranded conductor with an extrudable insulation provides particular advantages in the manufacture and dimensioning of the electric machine.

1. A stranded conductor for forming an electric conductor, in particular a subconductor, for a winding of an electric machine, comprising:
an arrangement of several mutually parallel and/or twisted filaments[[,]];
an insulation which surrounds an exterior circumference of the arrangement of filaments[[,]] and is applied around the arrangement of the filaments by extrusion; and
an elastic, extruded filling material which is made of a material different from a material of the insulation and is placed between the filaments.

2. The stranded conductor of claim 1, wherein the stranded conductor has a rectangular shape.

3.-4. (canceled)

5. The stranded conductor of claim 1, wherein the elastic, extruded filling material has a predetermined electrical conductivity[[,]]

6. The stranded conductor of claim 1, wherein the insulation applied by extrusion fills at least partially interstices between the plurality of filaments.

7. (canceled)

8. The stranded conductor of claim 1, further comprising an outer co-extruded conductive layer to form an exterior corona shielding[[,]] in the absence of an end corona shielding.

9. A method for producing electric conductors, in particular subconductors for a winding of an electric machines, comprising the steps of:
arranging several mutually substantially parallel and/or twisted filaments to form a stranded conductor[[, and]];
insulating the stranded conductor by extruding an insulation about an exterior circumference of the stranded conductor[[,]] ; and
filling a cavity between the filaments with an elastic, extruded filling material made of a material, which is different from a material of the insulation.

10. The method of claim 9, wherein the stranded conductor has a rectangular shape.

11.-13. (canceled)

14. The method of claim 9, wherein during the extrusion, the cavity between the filaments is at least partially filled with the insulation.

15. The method of claim 9, further comprising the step of introducing at least one material in at least one member selected from the group consisting of the insulation and[[/or in]] the filling material.

16. The method of claim 9, further comprising the step of producing an outer conducting layer operating as an exterior corona shielding by co-extrusion [[,]] in the absence of an end corona shielding

17. The stranded conductor of claim 1, wherein the filling material has a predetermined electric conductivity.

18. A winding for an electric machine sized for a predetermined maximum operating voltage, comprising a plurality of stranded conductors, each conductor including an arrangement of several mutually parallel and/or twisted filaments, an insulation which surrounds an exterior circumference of the arrangement of filaments and is applied around the arrangement of the filaments by extrusion, and an elastic, extruded filling material which is made of a material different from a material of the insulation and is placed between the filaments, wherein the insulation satisfies the requirements for a subconductor insulation.

19. The winding of claim 18, wherein the insulation satisfies the requirements of a primary insulation at least on portions of the exterior circumference about the arrangement of filaments.
